(19) United States
(12) Patent Application Publication
(10) Pub. No.: US 2004/0013107 A1
(43) Pub. Date: Jan. 22, 2004

(54) Method for providing an additional service for internet users

(76) Inventors: Ulrich Mitreuter, Konigsdorf (DE); Stefan Unger, Unterhaching (DE); Renate Zygan-Maus, Munich (DE)

Correspondence Address: MORRISON & FOERSTER LLP, 1650 TYSONS BOULEVARD, SUITE 300, MCLEAN, VA, 22102, US

(21) Appl. No.: 10/221,503

(22) PCT Filed: Apr. 30, 2001
(86) PCT No.: PCT/DE01/01633

(30) Foreign Application Priority Data
May 3, 2000 (EP) 00109457.2

(51) Int. Cl. H04L 12/66

(52) U.S. Cl. 370/352; 370/356

(57) ABSTRACT

The invention enables, in a simple manner, a telephone customer having an IP-based connection to the Internet via a personal computer (PC) to telephone, for instance, any public subscriber via said internet connection.

### DESCRIPTION

A process to make available a supplementary service for Internet users

1. What technical problem is intended to be solved by your invention?

2. How was this problem solved in the past?

3. In what way does your invention solve the indicated technical problem (state advantages)?

4. What is special about the invention?

Concerning Point 1:

It should be possible that a telephone customer who maintains an IP-based connection to the Internet through his/her Personal Computer (PC) is also able to make telephone calls through this Internet connection, for example, specifically to any arbitrary public subscriber and at his/her expense.

Concerning Point 2: How was this problem solved in the past? In the solutions formulated up to this point, the setup of a call is started through standardized protocols for IP telephony (H.323 or SIP) from the user's PC. For the identification, authentication and authorization of the user, for call control and for billing, IP telephony-specific server functions are needed (in addition to the media gateway functions necessary in any case to convert the voice information from TDM format to IP packets and vice versa).

Concerning Point 3: In what way does your invention solve the indicated technical problem (state advantages)? In the process according to the invention, functions of the telephone network are reused in order to make supplementary services (for example telephony services) available to the Internet user, with the aid of the telephone network, for the execution of which service protocols of the Internet are also necessary.

Below, the process according to the invention is described with an example using a known service, namely “Click-to-Dial (CtD)”:

Standard CtD is used at the CtD customer's expense, to enable any anonymous user to make a PSTN voice connection, which they can initiate over an HTTP interface.

In the application of the process according to the invention, the CtD message controls an IP telephone call (using a proprietary expanded standardized PINT protocol) and authenticates the user. The actual call setup is controlled completely from the telephone network and is billed from there. The VoIP connection to the user's PC is started from the telephone network. IP telephone connection-specific server functions for the identification, authentication and authorization of the user, for control of the call and for billing are not necessary; instead, functions of the CtD service are reused.

The process according to the invention can be used by a telephone network provider for all of its customers, independent of which switching center they are connected to and independent of which Internet service provider they have subscribed to for their Internet access. To set up the VoIP connection, VoIP-capable software for incoming calls must be installed on the PC of the Internet subscriber (for example Microsoft Netmeeting).

The order to set up a call in the PSTN is issued to the Click-to-Dial service through a standardized PINT protocol. An expanded version of the current PINT protocol, i.e. PINT+ is required to transport the IP address of the Internet subscriber.

Below, two variations of the example are explained in more detail (see FIGS. 1 and 2):

Variant a): The PINT+ Client Software (see note) is located on the termina 1 (for example the PC) of the Internet subscriber (see FIG. 1).

The Internet subscriber subscribes to the supplementary service with his/her telephone network provider. In contrast to standard CtD service, the Internet subscriber needs special software (PINT+ Client SW) on his/her PC that is made available to him/her by the provider.

Authentication of the Internet subscriber is done based on a password. The provider provides the Internet subscriber a default value for his/her password and a 4-digit random number. The database of the telephone network provider that contains the passwords of the Internet subscriber stores the default password in an encrypted form: The 4-digit random number depends on the default password and a SHA-1 hash value is generated using this value. This hash value (=encrypted password) is stored together with the random number and the length of the non-encrypted password (4-12 digits) in the subscriber database. The random number remains constant throughout the subscription period to the service, even if the Internet subscriber changes his/her password.

When the PINT+ Client Software is installed, the Internet subscriber is asked to input his/her directory number and the random number. This is stored by the program and used to generate the encrypted password as above. After the installation, the Internet subscriber uses his/her standard HTTP browser to change the default password through an HTTPS interface of his/her telephone network provider.

If the Internet subscriber would like to make a call through his/her Internet access, he/she starts the PINT+ Client Software, inputs the number that he/she would like to call and is then requested to provide his/her password. The PINT+ Client Software generates a PINT+ message with the connection data (directory number of the subscriber to connect to, IP address of the subscriber) and sends it to a PINT+ gateway server through IP/UDP using Click-to-Dial service logic of the telephone network provider. The PINT+ message contains an HMAC authenticator that was generated with the help of an encrypted password and that allows the authentication of the PINT+ packet and the determination that the data are undamaged. In addition, the Click-to-Dial service logic also generates the HMAC authenticator of the PINT+ message using the encrypted password stored in the subscriber database and compares this to the received HMAC authenticator.

The Click-to-Dial service logic initiates a call setup in the telephone network between the two directory numbers indicated in the PINT+ packet, using a Call Control Protocol (e.g. INAP). In the process, a VoIP connection is set up to the Internet subscriber through a media gateway, and the IP address of the Internet subscriber necessary for this purpose is taken from the PINT+ packet. The setup of the IP telephone connection can be done either over a Siemens Interworking Unit (proprietary transfer of the IP address) or through an arbitrary media gateway (in this case the PINT+ gateway server stores the IP address. It is known to the media gateway as the gatekeeper and is queried by it for the IP address). For the Internet subscriber, this is an incoming VoIP call that is placed to him/her through his/her VoIP application (for example Microsoft Netmeeting). The connection to the selected subscriber is normally set up through the PSTN and both connections are linked together through the CtD service.

Variant b): The PINT+ Client Software is located on a Web server in the Internet (see FIG. 2).

The Internet subscriber subscribes to the supplementary service with his/her telephone network provider. Authentication of the Internet subscriber is done based on a password. The provider provides the Internet subscriber a default value for his/her passwork and 4-digit random number as well as a Web page where he/she can change his/her password. The encrypted password is stored in the subscriber database and the password is changed as above.

If the Internet subscriber would like to make a call, he/she visits a HTTPS Web page of his/her telephone network provider using a standard HTTP browser on his/her terminal (for example his PC), said Web page having been set up for IP telephony service. The Internet subscriber is requested to input his/her password (and also the random number if it is the first time using the service). The Web server then writes the random number onto the PC of the Internet subscriber using a cookie so that he/she does not have to again enter the random number (which is not secret) together with the password in the future.

The Internet subscriber now enters the telephone number to be called (and if it is the first time using the service, his/her directory number), the PINT+ Client Software generates a PINT+ message that includes an authenticator for the user and sends this to a PINT+ gateway server through IP/UDP using the Click-to-Dial service logic of the telephone network provider. The directory number of the user is also written to the PC of the user using a cookie and is therefore known to the PINT+ Client upon later use of the service. Continued call setup between the two subscribers occurs through the Click-to-Dial service logic as in Variant a).

Note: The order to set up a call in the PSTN is issued to the Click-to-Dial service by means of the standardized PINT protocol. An expanded version of the current PINT protocol, i.e. PINT+ is required to transport the IP address of the Internet subscriber.

Advantages:

By means of the process described, a telephone network provider can offer to all of its customers telephony through an Internet connection as a supplementary service (Internet). The investment costs are minimized by reusing other functions of the telephone network.

No VoIP-specific infrastructure is required, for example no H.323 gatekeeper and no VoIP-specific subscription by the Internet subscriber. The Internet subscriber can also use his/her existing contract with the telephone network provider for IP telephone service, i.e. invoicing for normal telephone service and IP telephone service is done through a common bill.

It is possible to offer other supplementary Internet services with the same database for the user authentication.

Concerning Point 4:

What is special about the invention lies in the concept of a simple process to make available a supplementary service through Internet access that uses parts of standardized processes (H.323-, PINT-, HMAC-procedures), slightly supplemented by supplementary functions, and combine them such that economic use thereof is possible as a telecommunications supplementary service for a telephone network provider.

| | |
|---|---|
| References: | |
| PINT: | standardized in the IETF (Internet Engineering Task |
| | Force), Status: Proposed Standard RFC |
| HMAC: | standardized in the IETF: RFC 2104 |
| SHA-1: | standardized by the National Bureau of Standards, |
| | NBS FIPS PUB 113 “Computer Data Authentication” |
| Abbreviations: | |
| IP | Internet Protocol (s) |
| VoIP | Voice over IP |
| PC: | Personal Computer |
| PSTN: | Public Switched Telephone Network |
| PINT | PSTN/Internet Interworking |
| PINT+ | Expanded version of current PINT protocol |

1. A process to make available a supplementary service for Internet users, according to which
an Internet user who is on an IP-based connection through a terminal requests a supplementary service, proceeding from this IP-based connection,
said supplementary service is requested by means of a telephone network being tasked by a corresponding gateway component to perform the supplementary service,
the necessary connection to the terminal of the Internet user for the supplementary service is set up and controlled by the telephone network using a service protocol that is based on the Internet protocol.

2. A process according to claim 1,
characterized in that
said requested supplementary service is telephony service and said service protocol is a Voice-over-IP protocol.

3. A process according to claim 1 or 2,
characterized in that
said tasking is performed by said terminal itself.

4. A process according to claim 1 or 2,
characterized in that
a Web server is used to perform said tasking by said terminal.

5. A process according to one of claims 1 through 4,
characterized in that
the PINT protocol is used for said tasking, wherein the PINT protocol is supplemented to this end by the characteristic of transmitting the IP address of the user requesting the supplementary service.

6. A process according to one of claims 1 through 5,
characterized in that
a Click-to-Dial service logic is used by the gateway component to initiate the connection setup that is performed by the telephone network.

7. A process according to one of claims 1 through 6,
characterized in that
the communication of the gateway components with the telephone network is performed through the application protocol of the intelligent network (INAP).

8. A process according to one of claims 1 through 7,
characterized in that
billing for said requested supplementary service is controlled by the telephone network.
